(19) United States
(12) Patent Application Publication
(10) Pub. No.: US 2020/0191908 A1
(43) Pub. Date: Jun. 18, 2020

(54) Radio radar device capable of adapting to severe weather

(71) Applicant: Jicheng Liu, Ningbo City (CN)

(72) Inventor: Jicheng Liu, Ningbo City (CN)

(21) Appl. No.: 16/801,182

(22) Filed: Feb. 26, 2020

(30) Foreign Application Priority Data
Nov. 5, 2019 (CN) 2019110725382

(51) Int. Cl. G01S 7/40; H01Q 3/06; H01Q 15/16

(52) U.S. Cl. CPC G01S 7/40; H01Q 3/06; G01S 2007/027; G01S 2007/4043; H01Q 15/16

(57) ABSTRACT

The invention relates to the field of radio applications, and in particular to a radio radar device capable of adapting to severe weather. The invention includes a fuselage and a turret that is rotatably disposed above the fuselage. A radio radar, a protective cover rotatably connected to the rotating frame is provided above the radio radar, and a radio radar device capable of adapting to severe weather provided by the present invention can conveniently realize the turning of the radio radar. The protective cover can effectively protect the wireless radar in severe weather, and at the same time can ensure the normal operation of the radio radar. The device can be used in conjunction with the mobile trolley to facilitate the shipment. In addition, the equipment can lock itself on the trolley during the shipment process. It is safe and can use the shock absorber of the trolley to reduce the damage caused by bumps during the shipment of the equipment of the present invention, at the same time, the stability of the radar used during the shipment is improved, and it is more reliable.

### TECHNICAL FIELD

The invention relates to the field of radio applications, in particular to a radio radar device capable of adapting to severe weather.

### BACKGROUND OF THE INVENTION

In the process of radio applications, radio radar plays a vital role in the process of radio transmission and reception. Especially in severe weather, a reliable radio radar device is particularly important. Traditional radio radars are not protected during use. Severe weather severely affects the radar transmission effect, and traditional radio radars are inconvenient to use when checked in, and the traditional method is to use a trailer towing, which has extremely poor stability and is easy to cause radar damage. Radio Radar Device for Bad Weather Improves the Problem.

### BRIEF SUMMARY OF THE INVENTION

An object of the present invention is to provide a radio radar device capable of adapting to severe weather, which can overcome the above-mentioned shortcomings of the prior art, thereby improving the practicability of the device.

The technical solution adopted by the present invention to solve its technical problems is: a radio radar device capable of adapting to severe weather according to the present invention includes a fuselage and a turret rotatably disposed above the fuselage, and the top wall of the turret is left A radio radar is provided on the side that can swing left and right, and a protective cover that is rotatably connected to the turret is provided above the radio radar. A swing cavity with an upward opening is provided in the top wall of the turret, and the swing cavity can swing A reflecting plate for reflecting the radio transmitted by the radio radar is provided, and the reflecting plate swings under the action of a hydraulic rod hinged between the reflecting plate and the bottom wall of the swing cavity, so as to adjust the transmission of the radio radar. Radio reflection angle to avoid the degradation of radio transmission quality due to the limitation of the protective cover. When the weather is good, the protective cover is rotated by a quarter of a circle, at which time the radio radar is fully exposed, and at this time, the inside of the rotating frame The swinging device drives the radio radar to swing, thereby adjusting the radio radar transmission direction;

A scraper is slidably disposed on the outer surface of the reflecting plate, a first spring is provided between the scraper and the left end wall of the reflecting plate, and a winding device is provided in the left end wall of the swing cavity. The winding device can be independently rotated and moved from pulling the scraper through the pull wire, so as to facilitate clearing the snow on the surface of the reflecting plate in heavy snow weather;

The bottom of the fuselage is provided with four legs that can move up and down, and the legs are moved down by the pushing device provided in the fuselage, thereby lifting the fuselage and making the bottom of the fuselage The wall is separated from the truck of the consignment equipment. At this time, the equipment of the present invention can be fixed at any position. The front wall of the fuselage is downwardly provided with a front-rear symmetrical dovetail slot, and the dovetail slot is slidably provided with a card. Block, the clamping block can be moved toward each other under the action of a tensile device provided in the bottom wall of the fuselage, thereby fixing the fuselage and the truck body firmly to avoid slipping during re-consignment, the jacking The driving power of the device can switch and drive the rotation of the rotating frame under the action of the stretching device.

Further, the swinging device includes a first rotating shaft provided on the top wall of the rotating frame for fixing the radio radar, a first worm gear is fixedly disposed on an outer surface of the first rotating shaft, and the rotating frame is provided in the rotating frame. A transmission cavity is provided, and a first worm meshing with the first worm gear is rotatably disposed in a top wall of the transmission cavity. A first gear is fixedly disposed on an outer surface of the first worm in the transmission cavity. A sliding slot with an opening downward is provided in the top wall of the transmission cavity, and a sliding block is slidably provided in the sliding slot. A first motor is fixedly disposed in the bottom wall of the sliding block, and the end of the first motor output shaft is fixed A first gear matched with the first gear is provided, and a first threaded hole penetrating left and right is provided in the sliding block, and a first threaded rod is internally connected to the first threaded hole, and the first threaded rod is provided. The second motor is fixedly connected to the left end wall of the sliding groove, and the right end of the first threaded rod extends into a rotating cavity provided in the right end wall of the sliding groove. A bevel gear, so A second rotating shaft fixedly connected to the protective cover is rotatably provided in the first bevel gear, and a second bevel meshing with the first bevel gear is fixedly provided on the outer surface of the second rotating shaft in the rotating cavity gear.

Further, a push cavity is provided in the bottom wall of the transmission cavity, and a third rotation shaft is rotatably provided between the transmission cavity and the thrust cavity, and the third rotation shaft end in the transmission cavity is fixedly provided with A second gear meshed with the first gear is provided with a cam fixed at the end of the third rotating shaft in the ejection cavity, and a hydraulic pressure cavity is disposed in a right end wall of the ejection cavity. A first sliding hole is provided in communication between the pushing chambers, and a first pushing rod fixedly connected to a hydraulic pushing block slidingly arranged in the hydraulic chamber is slidably arranged in the first sliding hole. A second spring is provided between the first push rod and the right end wall of the push cavity, and a communication pipe is provided between the hydraulic cavity and the hydraulic rod to push the hydraulic push block to the right to squeeze Press the hydraulic oil in the hydraulic chamber into the hydraulic rod through the communication pipe, so as to drive the hydraulic rod to extend and push the reflection plate to rotate.

Further, the pushing device includes a first sliding cavity symmetrically arranged in the left and right sides of the fuselage, and a first sliding plate fixedly connected to the leg is slidably disposed in the first sliding cavity. A second threaded hole penetrating up and down is provided in the first sliding plate, a second threaded rod is internally connected to the second threaded hole, and the top end of the second threaded rod extends into the top wall of the first sliding cavity. A first sprocket is fixedly disposed at the end of the sprocket cavity, and a second sliding cavity is provided in the top wall of the sprocket cavity. A fourth rotating shaft is rotated between the second sliding cavity and the sprocket cavity. A first spline cap is fixedly provided at the end of the fourth rotating shaft in the second sliding cavity, and a second sprocket is fixedly provided at the end of the fourth rotating shaft in the sprocket cavity, and the second sprocket and A pair of left and right first sprocket wheels are connected by a chain transmission, and a fifth rotating shaft fixedly connected to the rotating frame is rotatably disposed in the top wall of the second sliding cavity. A second spline cap is fixedly disposed at the end of the fifth rotating shaft, and the second A second sliding plate is slidably disposed in the movable cavity, and a third motor with an output shaft and the second spline cap splined is fixedly disposed in the second sliding plate, and the second sliding plate moves up and down to thereby Drive the third motor to move up and down, so that the output shaft of the third motor is matched with the second spline cap and the first spline cap, respectively, so as to realize power switching.

Further, the stretching device includes a worm wheel cavity provided in the bottom wall of the fuselage, a winding cavity is symmetrically arranged on the left and right sides of the worm gear cavity, and a symmetrical rotation is provided between the left and right winding chambers. A sixth rotating shaft penetrating the worm wheel cavity, a winding wheel is fixedly arranged at the end of the sixth rotating shaft in the winding cavity, and an outer surface of the winding wheel is provided with a pull wire fixedly connected to the clamping block; A third spring is disposed between the clamping block and the end wall of the dovetail groove, and a second worm gear is fixedly disposed on the outer surface of the sixth rotation shaft in the worm wheel cavity. A second worm that is engaged by both of the second worm wheels, a third sliding cavity is provided in the top wall of the worm wheel cavity, and a third sliding plate is slidably provided in the third sliding cavity, and the third sliding A back-to-back symmetrical second sliding hole is provided in communication between the cavity and the second sliding cavity, and the second sliding hole is slidably provided with both the third sliding plate and the second sliding plate. A second pusher, and the third sliding plate is provided with vertical movement A third threaded hole, the third threaded hole is internally threaded with a third threaded rod fixedly connected to the second worm, and the top end of the third threaded rod is fixedly disposed in the top wall of the third sliding cavity. The fourth motor is powered.

Beneficial effects of the present invention: A radio radar device capable of adapting to severe weather provided by the present invention can conveniently realize the turning of the radio radar. At the same time, a protective cover is provided in the device, which can effectively protect the wireless radar in severe weather, and can To ensure the normal operation of the radio radar, the device can be used in conjunction with the mobile cart to facilitate the consignment, and the device can lock itself above the cart during the consignment process. It is safer and can use the vehicle s own shock-absorbing device to reduce The damage caused by bumps during the shipment of the equipment, while improving the stability and reliability of the radar used during the shipment.

### BRIEF DESCRIPTION OF THE DRAWINGS

In order to more clearly explain the embodiments of the invention or the technical solutions in the prior art, the drawings used in the description of the embodiments or the prior art are briefly introduced below. Obviously, the drawings in the following description are merely For some embodiments of the invention, for those of ordinary skill in the art, other drawings can be obtained based on these drawings without paying creative labor.

The invention is further described below with reference to the drawings and embodiments.

FIG. 1 is a schematic diagram of the overall structure of a radio radar device capable of adapting to severe weather according to the present invention.

FIG. 2 is a schematic structural diagram of A-A in FIG. 1.

FIG. 3 is a schematic enlarged view of B in FIG. 1.

FIG. 4 is an enlarged schematic view of C-C in FIG. 3.

FIG. 5 is an enlarged structural diagram of D in FIG. 1.

### DETAILED DESCRIPTION OF THE INVENTION

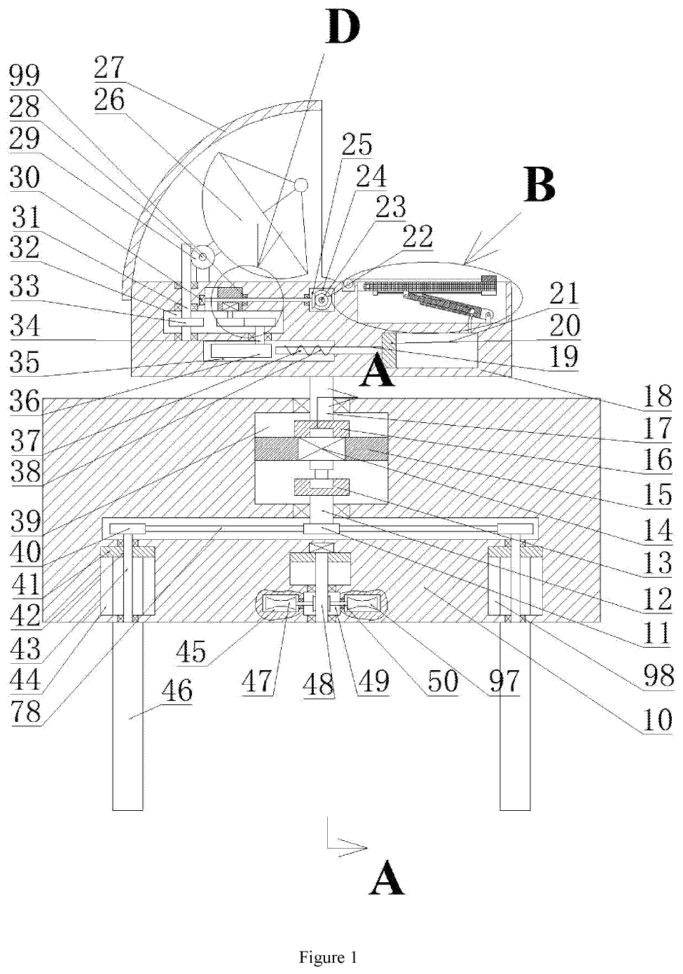

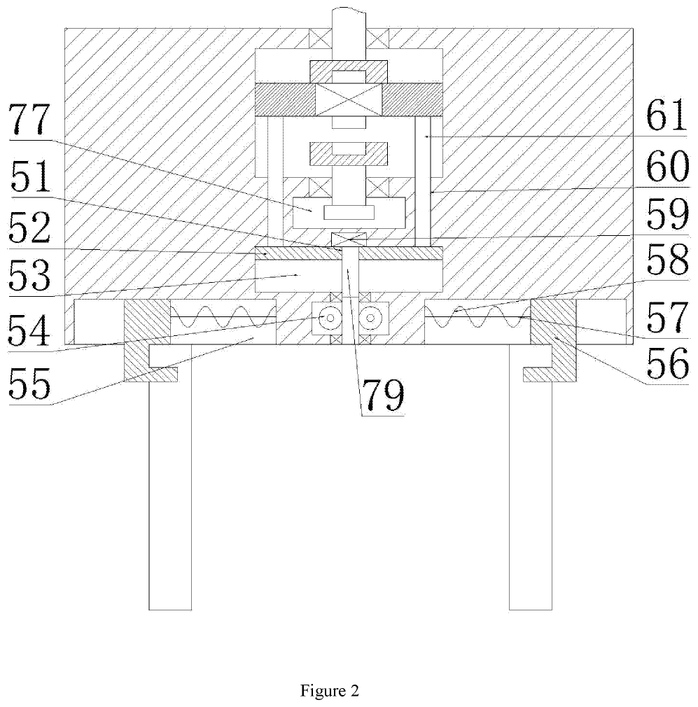

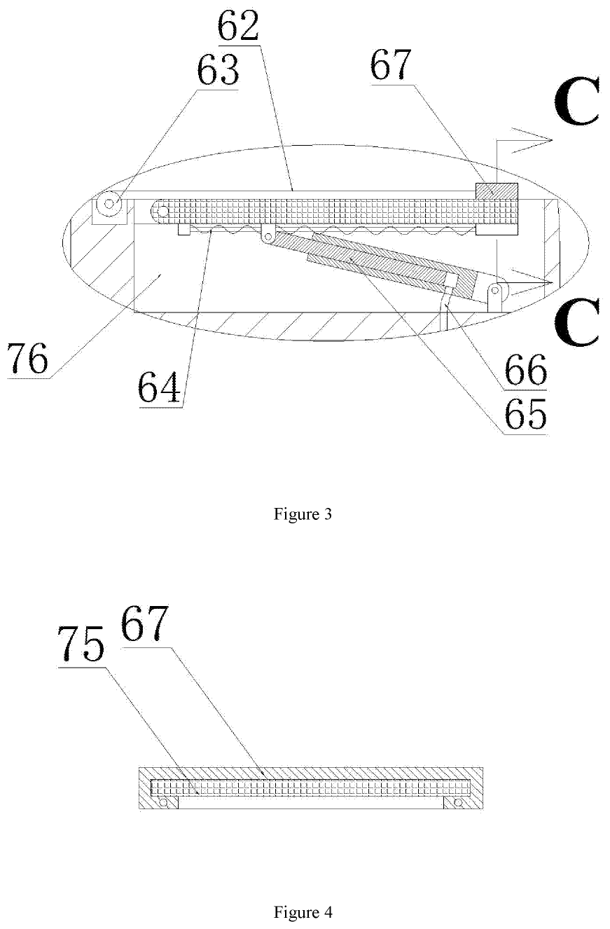

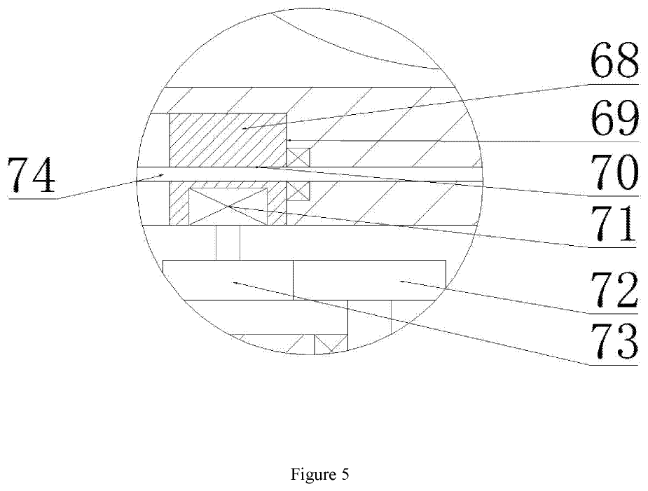

The present invention will be described in detail below with reference to FIGS. 1-5. For convenience of description, the orientation described below is defined as follows: the up-down, left-right, front-back direction described below is consistent with the up-down, left-right, front-back direction of the projection relationship of FIG.

A radio radar device capable of adapting to severe weather, as described in conjunction with FIGS. 1-5, includes a fuselage 10 and a rotating frame 18 rotatably disposed above the fuselage 10. The left side of the top wall of the rotating frame 18 can be left and right. A radio radar 26 is oscillated, and a protective cover 27 rotatably connected to the turret 18 is provided above the radio radar 26. A swing cavity 76 with an upward opening is provided in the top wall of the turret 18, and the oscillating cavity A reflecting plate 75 for reflecting the radio transmitted by the radio radar 26 is swingably provided in 76. The reflecting plate 75 is under the action of a hydraulic rod 65 hinged between the reflecting plate 75 and the bottom wall of the swing cavity 76. Swing to adjust the radio reflection angle sent by the radio radar 26 to avoid the degradation of radio transmission quality due to the limitation of the protective cover 27. When the weather is good, rotate the protective cover 27 by a quarter of a circle. The radio radar 26 is completely exposed. At this time, a swinging device 99 provided in the turret 18 drives the radio radar 26 to swing, thereby adjusting the emission direction of the radio radar 26;

A scraper 67 is slidably disposed on the outer surface of the reflecting plate 75. A first spring 64 is disposed between the scraping plate 67 and the left end wall of the reflecting plate 75, and a left end wall of the swing cavity 76 is disposed in There is a winding device 63, which can be independently rotated and moved from the scraper 67 by pulling through the pull wire 62, so as to facilitate the snow cleaning of the surface area of the reflecting plate 75 in heavy snow weather;

The bottom of the fuselage 10 is provided with four movable legs 46 that can be moved up and down. The legs 46 are moved downward by the pushing device 98 provided in the fuselage 10, thereby lifting the fuselage 10. The bottom wall of the fuselage 10 is detached from the truck of the consignment equipment. At this time, the device of the present invention can be fixed at any position. An opening in the top wall of the fuselage 10 is provided with a front-rear symmetrical dovetail groove 55. A clamping block 56 is slidably arranged in the dovetail groove 55, and the clamping block 56 can be moved toward each other under the action of a stretching device 97 provided in the bottom wall of the fuselage 10, thereby fixing the fuselage 10 and the truck compartment. It is firm to avoid slipping during re-consignment. The driving force of the pushing device 98 can switch the rotation of the rotating frame 18 under the action of the stretching device 97.

Advantageously, the swinging device 99 includes a first rotating shaft 28 fixed on the top wall of the rotating frame 18 for fixing the radio radar 26, and a first worm gear 29 is fixed on the outer surface of the first rotating shaft 28. A transmission cavity 32 is provided in the rotating frame 18, and a first worm 31 meshing with the first worm gear 29 is rotatably disposed in a top wall of the transmission cavity 32. A first gear 33 is fixedly disposed on the outer surface of the worm 31, and a sliding groove 69 with an opening downward is provided in the top wall of the transmission cavity 32. A sliding block 68 is slidably disposed in the sliding groove 69. A first motor 71 is fixedly disposed in the bottom wall, and a first gear 73 cooperating with the first gear 33 is fixedly disposed at the end of the output shaft of the first motor 71. A threaded hole 70, the first threaded hole 70 is internally screwed with a first threaded rod 74, and the first threaded rod 74 is dynamically connected with a second motor 30 fixedly disposed in the left end wall of the sliding groove 69; The right end of the first threaded rod 74 extends into the right end wall of the sliding groove 69 and is provided. A first bevel gear 25 is fixedly disposed at the end of the rotating cavity 24, and a second rotating shaft 23 fixedly connected to the protective cover 27 is rotatably disposed in the first bevel gear 25. A second bevel gear 22 meshing with the first bevel gear 25 is fixed on an outer surface of the second rotating shaft 23.

Beneficially, a pushing cavity 35 is provided in the bottom wall of the transmission cavity 32, and a third rotation shaft 34 is rotatably provided between the transmission cavity 32 and the thrust cavity 35, and the first A second gear 72 meshing with the first gear 73 is fixedly provided at the end of the three rotating shafts 34, and a cam 36 is fixedly provided at the end of the third rotating shaft 34 in the pushing cavity 35, and the right side of the pushing cavity 35 is fixed. A hydraulic chamber 21 is provided in the end wall, and a first sliding hole 19 is provided in communication between the hydraulic chamber 21 and the pushing chamber 35. The first sliding hole 19 is slidably provided with the hydraulic chamber. The first push rod 37 fixedly connected to the hydraulic push block 20 provided in 21 is provided with a second spring 38 between the first push rod 37 and the right end wall of the push cavity 35. The hydraulic cavity A communication pipe 66 is provided between 21 and the hydraulic rod 65, and the hydraulic push block 20 is pushed to the right to squeeze the hydraulic oil in the hydraulic chamber 21 into the hydraulic rod 65 through the communication pipe 66. Therefore, the hydraulic rod 65 is extended to push the reflection plate 75 to rotate.

Advantageously, the pushing device 98 includes a first sliding cavity 44 symmetrically arranged in the left and right sides of the fuselage 10, and a first sliding cavity 44 fixedly connected to the leg 46 is slidably disposed in the first sliding cavity 44. The sliding plate 41 is provided with a second threaded hole 42 penetrating up and down in the first sliding plate 41. A second threaded rod 43 is threadedly connected to the second threaded hole 42. The top end of the second threaded rod 43 extends. A first sprocket 40 is fixedly inserted into a sprocket cavity 77 provided in the top wall of the first sliding cavity 44 and a second sliding cavity 39 is provided in the top wall of the sprocket cavity 77. The second A fourth rotating shaft 12 is rotated between the sliding cavity 39 and the sprocket cavity 77, and a first spline cap 13 is fixedly disposed at the end of the fourth rotating shaft 12 in the second sliding cavity 39, and the sprocket cavity 77 A second sprocket 11 is fixedly disposed at the end of the fourth rotating shaft 12 inside, and the second sprocket 11 and the left and right two first sprockets 40 are driven and connected by a chain 78, and the second slide A fifth rotating shaft 17 fixedly connected to the rotating frame 18 is rotatably provided in the top wall of the cavity 39, and the first sliding shaft 39 in the second sliding cavity 39 A second spline cap 16 is fixedly disposed at the end of the five rotation shafts 17. A second sliding plate 15 is slidably disposed in the second sliding cavity 39. An output shaft and the first sliding plate 15 are fixedly disposed in the second sliding plate 15. The third motor 14 that is splined with the two spline caps 16 moves the second sliding plate 15 up and down to drive the third motor 14 up and down, so that the output shaft of the third motor 14 and the second motor 14 are respectively The splined cap 16 and the first splined cap 13 are spline-fitted, so as to realize power switching.

Advantageously, the stretching device 97 includes a worm wheel cavity 49 provided in the bottom wall of the fuselage 10, and the left and right sides of the worm wheel cavity 49 are symmetrically provided with a winding cavity 45. A sixth rotating shaft 50 penetrating the worm wheel cavity 49 is arranged symmetrically between front and back. A winding wheel 47 is fixedly disposed at the end of the sixth rotating shaft 50 in the winding cavity 45. The outer surface of the winding wheel 47 is wound around A pull wire 57 is fixedly connected to the clamping block 56. A third spring 58 is disposed between the clamping block 56 and the end wall of the dovetail groove 55. The outer surface of the sixth rotating shaft 50 in the worm wheel cavity 49. A second worm wheel 54 is fixedly provided, and a second worm 48 is rotatably provided in the worm wheel cavity 49 and is engaged with both the front and rear second worm wheels 54. A third slide is provided in the top wall of the worm wheel cavity 49. A cavity 53 is provided with a third sliding plate 52 slidably disposed in the third sliding cavity 53, and a second sliding hole 60 symmetrically arranged in front and rear is provided between the third sliding cavity 53 and the second sliding cavity 39. The second sliding hole 60 is slidably disposed to be fixed to the third sliding plate 52 and the second sliding plate 15. A second pusher 61, a third threaded hole 51 penetrating up and down is provided in the third sliding plate 52, and a third thread fixedly connected to the second worm 48 is threaded in the third threaded hole 51. A rod 79, a top end of the third threaded rod 79 is dynamically connected to a fourth motor 59 fixedly disposed in a top wall of the third sliding cavity 53.

The fixed connection method described in this embodiment includes, but is not limited to, methods such as bolt fixing and welding.

As shown in FIGS. 1-5, in the device of the present invention, in the initial state, the second sliding plate 15 is located above the second sliding cavity 39, the output shaft of the third motor 14 and the second spline cap 16 Spline fit, the third spring 58 is in a compressed state.

The sequence of mechanical actions of the entire device:

1. When the device of the present invention works in severe weather, the first motor 71 is started to drive the first gear 73 to rotate, thereby driving the second gear 72 to rotate, thereby driving the cam 36 to rotate, thereby driving the The first ejector rod 37 moves to squeeze the hydraulic oil in the hydraulic chamber 21 into the hydraulic rod 65 through the communication pipe 66. The hydraulic rod 65 is extended to push the reflection plate 75 upward. Adjust the angle to adjust the radio reflection angle emitted by the radio radar 26, and at the same time start the third motor 14 to drive the fifth rotating shaft 17 to rotate, thereby driving the turret 18 to rotate, thereby adjusting the radio direction. The radio radar 26 is in the protective state of the protective cover 27, which is sufficient to cope with various severe weather. When snowy weather occurs, the winding device communication pipe 66 is activated to pull the pull wire 62, thereby driving the scraper. 67 movement, the movement of the scraper 67 can remove the rain and snow covering the surface of the reflection plate 75, thereby ensuring the reflection efficiency of the reflection plate 75;

2. When the weather is good, starting the second motor 30 drives the first threaded rod 74 to rotate, thereby driving the first bevel gear 25 to rotate, thereby driving the second bevel gear 22 to rotate, thereby driving the The second rotating shaft 23 rotates, thereby driving the protective cover 27 to rotate, thereby completely exposing the radio radar 26 to the outside. At this time, because the first threaded rod 74 rotates, the sliding block 68 moves to the left, thereby driving all The first gear 73 moves to the left to mesh with the first gear 33. At this time, the first motor 71 is started to drive the first gear 73 to rotate, thereby driving the first gear 33 to rotate, thereby driving the first gear The worm 31 rotates, thereby driving the first worm wheel 29 to rotate, and the first worm wheel 29 rotates to adjust the angle of the radio radar 26. At this time, the third motor 14 is started to drive the fifth rotation shaft 17 to rotate, thereby driving all The turret 18 rotates to adjust the radio direction. At this time, the radio radar 26 can send and receive radios freely. At this time, the radio loss when the reflection plate 75 reflects can be reduced;

3. When the device of the present invention moves, starting the fourth motor 59 rotates and drives the third threaded rod 79 to rotate, thereby driving the second worm 48 to rotate, thereby driving the second worm wheel 54 to rotate, thereby driving The reel 47 is rotated, and the reel 47 is rotated to release the surface pull wire 57. At this time, the clamping block 56 is moved forward and backward at the same time, and the third threaded rod 79 is rotated to drive the third slide. The plate 52 is moved down, so that the second pusher 61 is moved down, so that the second slide plate 15 is moved down, so that the third motor 14 is moved down, and the output shaft is inserted into the first spline. The cap 13 is splined into it, and the third motor 14 is started to drive the fourth rotating shaft 12 to rotate, thereby driving the second sprocket 11 to rotate, thereby driving the first sprocket 40 to rotate, As a result, the first sliding plate 41 is driven to move down. Since the legs 46 are in contact with the ground at this time, the fuselage 10 is moved up and lifted at this time. At this time, the checker cart is poured from left to right into the front and back two. Group the legs 46, so that the equipment is directly above the check-in trolley, at this time the third The machine 14 drives the fourth rotating shaft 12 to rotate in the reverse direction, thereby driving the second sprocket 11 to rotate in the reverse direction, thereby driving the first sprocket 40 to rotate in the reverse direction, thereby driving the first sliding plate 41 to move up Therefore, the leg 46 is driven upward to move away from the ground. At this time, the fourth motor 59 is started to rotate in the reverse direction, thereby driving the third threaded rod 79 to rotate in the reverse direction, thereby driving the second worm 48 to rotate in the reverse direction. Therefore, the second worm wheel 54 is driven to rotate in the reverse direction, so that the reel wheel 47 is rotated in the reverse direction, so that the reel wheel 47 is rotated to wind the second worm 48, and the second worm 48 pulls the The card block 56 is moved to the middle of the device, so that the card block 56 is re-checked on both sides of the trolley, thereby fixing the device on the trolley;

4. When the third threaded rod 79 rotates in the reverse direction, the third sliding plate 52 moves up, thereby driving the second push rod 61 to move up, thereby driving the second sliding plate 15 up, and Drive the third motor 14 upward to insert the output shaft into the second splined cap 16 and cooperate with the spline. At this time, the cart moves, and at the same time, steps 1 and 2 can be performed to realize the radio radar while moving. Transmit to receive radio.

The above embodiments are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. A radio radar device capable of adapting to severe weather includes a fuselage and a turret rotatably disposed above the fuselage, and is characterized in that a radio radar is provided on the left side of the top wall of the turret so that it can swing left and right. A protective cover that is rotatably connected to the turret is provided above the radio radar, and a swing cavity with an upward opening is provided in the top wall of the turret, and a swing for radiating radio signals sent by the radio radar is provided in the swing cavity. The reflecting plate swings under the action of a hydraulic rod hinged between the reflecting plate and the bottom wall of the swing cavity, so as to adjust the radio reflection angle sent by the radio radar to avoid the radio caused by the limitation of the protective cover. The transmission quality decreases. When the weather is good, the protective cover is rotated by a quarter of a circle. At this time, the radio radar is fully exposed. At this time, a swing device provided in the turret drives the radio radar to swing, thereby adjusting. The radio radar emission direction;
a scraper is slidably disposed on the outer surface of the reflecting plate, a first spring is provided between the scraper and the left end wall of the reflecting plate, and a winding device is provided in the left end wall of the swing cavity. The winding device can be independently rotated and moved from pulling the scraper through the pull wire, so as to facilitate clearing the snow on the surface of the reflecting plate in heavy snow weather;
the bottom of the fuselage is provided with four legs that can move up and down, and the legs are moved down by the pushing device provided in the fuselage, thereby lifting the fuselage and making the bottom of the fuselage The wall is separated from the truck of the consignment equipment. At this time, the equipment of the present invention can be fixed at any position. The front wall of the fuselage is downwardly provided with a front-rear symmetrical dovetail slot, and the dovetail slot is slidably provided with a card. Block, the clamping block can be moved toward each other under the action of a tensile device provided in the bottom wall of the fuselage, thereby fixing the fuselage and the truck body firmly to avoid slipping during re-consignment, the jacking The driving power of the device can switch and drive the rotation of the rotating frame under the action of the stretching device.

2. The radio radar device capable of adapting to severe weather according to claim 1, characterized in that the swinging device comprises a first rotating shaft for fixing the radio radar, which is rotatably disposed on the top wall of the turret, and A first worm gear is fixedly disposed on the outer surface of the first rotating shaft, and a transmission cavity is disposed in the rotating frame. A first worm meshing with the first worm gear is rotatably disposed in the top wall of the transmission cavity. A first gear is fixedly disposed on the outer surface of the first worm, and a sliding groove with an opening downward is provided in the top wall of the transmission cavity. A sliding block is slidably disposed in the sliding groove, and the bottom of the sliding block is provided. A first motor is fixedly disposed in the wall, a first gear cooperating with the first gear is fixedly disposed at an end of the first motor output shaft, and first and second threaded holes penetrating through the left and right are provided in the sliding block. A threaded hole is internally threaded with a first threaded rod, and the first threaded rod is dynamically connected to a second motor fixedly arranged in the left end wall of the sliding groove, and the right end of the first threaded rod extends into the Sliding groove A first bevel gear is fixedly disposed in the rotating cavity provided in the right end wall, and a second bevel shaft fixedly connected to the protective cover is rotatably provided in the first bevel gear. A second bevel gear that meshes with the first bevel gear is fixed on the outer surface of the second rotating shaft.

3. The radio radar device capable of adapting to severe weather according to claim 2, characterized in that: a thrust cavity is provided in the bottom wall of the transmission cavity, and a first A three-rotation shaft, a second gear meshing with the first gear is fixedly provided at the end of the third rotation shaft in the transmission cavity, and a cam is fixedly provided at the end of the third rotation shaft in the ejection cavity, A hydraulic pressure cavity is provided in the right end wall of the pushing cavity, and a first sliding hole is provided in communication between the hydraulic pressure cavity and the pushing cavity. The first sliding hole is slidably provided with the hydraulic pressure cavity. A first push rod fixedly connected by a hydraulic push block provided inside, a second spring is provided between the first push rod and a right end wall of the push cavity, and the hydraulic cavity and the hydraulic rod The communication tube is provided with a communication tube, and the hydraulic push block is pushed to the right, so as to squeeze the hydraulic oil in the hydraulic chamber into the hydraulic rod through the communication tube, thereby driving the hydraulic rod to extend and push the reflection. The board rotates.

4. The radio radar device capable of adapting to severe weather according to claim 1, wherein the pushing device comprises a first sliding cavity symmetrically arranged in the left and right sides of the fuselage, and the first sliding cavity is slidable. A first sliding plate fixedly connected to the leg is provided, and a second threaded hole penetrating up and down is provided in the first sliding plate, and a second threaded rod is threadedly connected to the second threaded hole. The top end of the second threaded rod extends into a sprocket cavity provided in the top wall of the first sliding cavity, and a first sprocket is fixedly disposed at the end, and a second sliding cavity is provided in the top wall of the sprocket cavity. A fourth rotating shaft is rotated between the second sliding cavity and the sprocket cavity, and a first spline cap is fixedly disposed at an end of the fourth rotating shaft in the second sliding cavity. A second sprocket is fixedly arranged at the end of the four rotation shafts, and the second sprocket and the left and right two first sprockets are connected by a chain transmission. The top wall of the second sliding cavity is rotatably provided with a A fifth rotating shaft fixedly connected to the rotating frame, the second slide A second spline cap is fixedly disposed at the end of the fifth rotating shaft in the movable cavity, and a second sliding plate is slidably disposed in the second sliding cavity. The output shaft and the second sliding plate are fixedly disposed in the second sliding plate. The third motor that is splined with the second spline cap is moved up and down on the second sliding plate to drive the third motor to move up and down, so that the output shaft of the third motor and the second spline cap are respectively realized. And the first splined cap is splined to achieve power switching.

5. The radio radar device capable of adapting to severe weather according to claim 1, characterized in that the stretching device comprises a worm gear cavity provided in the bottom wall of the fuselage, and the left and right sides of the worm gear cavity are symmetrically provided with windings. A wire cavity, and a sixth rotating shaft penetrating the worm wheel cavity is symmetrically rotated back and forth between the left and right winding holes, and a winding wheel is fixedly arranged at the end of the sixth rotating shaft in the winding cavity. A pull wire fixedly connected to the clamping block is wound on the outer surface of the reel, and a third spring is arranged between the clamping block and the end wall of the dovetail groove. A second worm gear is provided, and a second worm that is engaged with both the front and rear second worm gears is rotatably provided in the worm gear cavity. A third sliding cavity is provided in the top wall of the worm gear cavity. A third sliding plate is slidably disposed in the sliding cavity, and a second sliding hole symmetrically arranged in front and rear is provided between the third sliding cavity and the second sliding cavity. The second sliding hole is slidably disposed in the second sliding hole. There is a connection between the third sliding plate and the second A second ejector rod with a fixed sliding plate, a third threaded hole penetrating up and down is provided in the third sliding plate, and a third thread fixedly connected to the second worm is threaded in the third threaded hole. A rod, the top end of the third threaded rod is power-connected to a fourth motor fixedly arranged in the top wall of the third sliding cavity.
